(19) United States
(12) Patent Application Publication
(10) Pub. No.: US 2004/0035775 A1
(43) Pub. Date: Feb. 26, 2004

(54) MemCoatTM: functionalized surface coatings, products and uses thereof

(75) Inventors: Alex G. Bonner, Lexington, MA (US); Richard A. Laursen, Newton, MA (US); Lawrence M. Udell, Newton, MA (US); Leon Mir, Newton, MA (US); Ting Chen, Brighton, MA (US); Tung-Feng Yeh, Waltham, MA (US)

Correspondence Address: LAHIVE & COCKFIELD, LLP., 28 STATE STREET, BOSTON, MA, 02109, US

(73) Assignee: BioLink Partners, Inc., Watertown, MA

(21) Appl. No.: 10/453,473

(22) Filed: Jun. 2, 2003

Related U.S. Application Data
(60) Provisional application No. 60/384,527, filed on May 31, 2002.

(51) Int. Cl. B01D 15/08

(52) U.S. Cl. 210/198.2; 530/350; 424/193.1

(57) ABSTRACT

The present invention features a coating consisting of a functionalized polymeric surface coating comprising reactive entities. These entities could consist of amino-, hydroxyl; epoxy- or other covalently linked in a polymer network of polyurea and polyurethane to provide a surface coating. This functionalized coating is applied to surfaces of a non-woven material composed of fibers. One embodiment of present invention is application to fibers at a level of 0.01 to 1 micromole/cm² amine without poragens to be utilized for peptide and combinational chemistry synthesis. Furthermore, the coating can be applied to fiber at a high level with a crinkly fiber coating abased on the use of a poragen, thus creating a matrix having a higher loading on higher surface area for synthesis and other applications. These embodiments may be applied to various fields and technologies, e.g., proteomics, genomics, combinatorial chemistry, and chromatography.

### RELATED APPLICATIONS

This application claims priority to U.S. Provisional Application No. 60/384,527 entitled “Functionalized Surface Coatings, Products and Uses Thereof” filed on May 31, 2002, the entire contents of which are incorporated herein by reference.

### GOVERNMENT SUPPORT

Work described herein was supported at least in part by the Nation Institutes of Health (NIH) Grants 1-R41 RR105017-01 (Phase I) and 9-R42-GM65820-02 (Application No. 2R44RR15017-02 (Phase II). The U.S. government therefore may have certain rights in this invention.

Furthermore, the NIH grant applications include the Phase I Research Report, the Phase-I Application which was submitted March, 1998, the Revised Phase-I Application submitted to NIH July, 1998, the Phase-II Application submitted to NIH November, 2000, and the Revised Phase-II Application submitted November, 2000, the entire contents of which are incorporated herein by reference.

### FIELD OF THE INVENTION

This invention relates generally to a functionalized polymeric surface coating that may be applied to various fields and technologies, such as, proteomics, genomics, combinatorial chemistry, and chromatography.

### BACKGROUND OF THE INVENTION

There are numerous publications and patents for media, surfaces, and membranes that have been modified with a surface coating (see U.S. Pat. Nos. 5,030,352, 4,618,533, 4,923,901, 5,011,861, and 6,218,016 B1). In addition, there are numerous papers regarding the use of membranes or surfaces for synthesis and analysis of biomolecules (see Wang, Carney, and Laursen, Epitopic Characterization of the Human Wild-type and Mutant RAS Proteins Using Membrane-bound Peptides, J. Peptide Res. 50 (1997) 483-492; Duan and Laursen, Protease Substrate Specificity Mapping Using Membrane-Bound Peptides, Anal. Biochemistry 216 (1994) 431-438; S. Borman, Combinatorial Synthesis Hits the Spot, C&E News, Jul. 3, 2000, pp 25-27; Fitzpatrick, R., Goddard, P, Stankowski, R. and Coull, J., Hydrophilic Membrane Supports for DNA Synthesis. (1994), in Innovations and Perspectives in Solid Phase Synthesis, R. Epton, ed., Mayflower Worldwide Ltd., Birmingham UK, pp 157-162; Daniels, Bernatowicz, J. Coull and H. Koster, Membranes as Solid Supports for Peptide Synthesis, Tett Letters 30 (1989) 4345-4348; Strategies and Techniques in Simultaneous Solid Phase Synthesis Based on the Segmentation of Membrane Type Supports, Biorg. & Med. Chem. Letters 3 (1993) 425-430; Stankova, Wade, Lam, and Lebl, Synthesis of Combinatorial Libraries with Only One Representation of Each Structure, Peptide Res., 7 (1994) 292-298; Scharn, Wenschuh, Reineke, Schneider-Mergener, and Germeroth, Spatially Addressed Synthesis of Amino- and Amino-Oxy-Substituted 1,3,5-Triazine Arrays on Polymeric Membranes,J. Comb. Chem. 2 (2000) 361-369; Matson, Rampal, and Coassin, Biopolymer Synthesis on Polypropylene Supports, Anal. Biochemistry 217 (1994) 306-310; U.S. Pat. No. 6,083,682; Frank, R., Spot-synthesis: An Easy Technique for the Positionally Addressable, Parallel Chemical Synthesis on a Membrane Support, Tetrahedron Lett. 48, 9217-9232 (1991); and Wang, Z. and Laursen, R. A., Multiple Peptide Synthesis on Polypropylene Membranes for Rapid Screening of Bioactive Peptides, Peptide Res. 5, 275-280 (1992). Furthermore, there are a number of membrane products sold commercially (e.g. Pall Corps., Mustang Disposable Capsules and cartridges, and other similar products from Millipore, Cuno, and the like).

In light of this prior art, previously known membranes modified with a surface coating are the result of modifying an inert, polymeric membrane having a sub-micron pore structure in such a manner that, generally, a uni-molecular surface coating is obtained. Therefore, the existing sub-micron pores are not occluded by the polymeric coating and a very thin surface coating is obtained. Also, the large surface area of the sub-micron membrane is maintained and functional groups are delivered to this surface area by the uni-molecular coating.

The present invention differs from these earlier examples in that a much thicker polymeric coating is applied to a surface and a large surface area is obtained as the combined result of the porous structure of the polymeric coating itself and the structure of the surface (e.g., the density and diameter of the fibers in a woven or non-woven fabric). In this manner, a material, surface or membrane can be fabricated having a large surface area, a large number of reactive entities, and a macro-structure that does not significantly inhibit the flow rate of solvents and reagents over the reactive entities as is the case for membranes with sub-micron pores.

The present invention also features the use of a liquid precipitant to provide polymerization induced phase separation (PIPS) for a cross-linked polymer with a microgelation morphology, an agglomerization of sub-micron sized particles, and a product with high specific surface area has been reported by others (see also U.S. Pat. Nos. 4,256,840, 4,382,124, and 4,224,415; React. Polymers., 4 (1986) 155; Stover, H., Polymer Morphology Map, Http://unicorn.mcmaster.ca/beamlines/SMW4-report/SMW4-stover.pdf; Abrams, I. M. and Millar, J. R., A History of the Origin and Development of Macroporous Ion-exchange Resins, Reactive & Functional Polymers 35, 7-22, (1997); and Sherrington, Preparation, Structure, and Morphology of Polymer Supports, D.C. www.rsc.org/pdf/chemcomm/D9803757.pdf). This technology has previously been used in suspension polymerization methods to prepare resin beads and has been applied to polystyrene-divinylbenzene, controlled pore glass, and other polymers. However, the PIPS process has not been previously utilized for polymerization processes in which one monomer unit approaches another monomer unit containing a precipitant solvent in an interfacial manner.

Papers by Sherrington and by Abrams and Millar provided a detailed discussion of the concepts of the use of a precipitant solvent (see id.). Generally, there is a physical parameter called ‘cohesive energy density,’ which is a characteristic of solvents and polymers. A good precipitant solvent is one that has a cohesive energy density that is similar to the cohesive energy density of the polymer. In the present invention, for example, a polyurea is formed and these polymers have cohesive energy densities of 22.9 (see Brandrup and Innergut data from the Polymer Handbook). The precipitant solvent used in our example is dimethylformamide (DMF) with a cohesive energy density of 24.8. There are a number of other solvents listed in the Polymer Handbook that are expected to provide similarly to DMF for the formation of polyureas having the microgelation morphology (see supra).

Another important aspect of the invention is its use in applications, such as chromatography. Chromatography is an important separation process used for the purification of compounds, e.g., pharmaceutical compounds, proteins, and peptides. Until now, chromatography used chromatographic packings, which are typically beads ranging from 10 to over 200 microns in diameter, most commonly composed of water-swollen gels, and impose undesirable restrictions and characteristics on the practice of chromatography. The most significant of these restrictions relates to the use of relatively large beads which greatly slow down the diffusion of desired compounds to be separated into the interior of the beads. Therefore, to obtain adequate separation among these compounds, the flow of solution though the chromatographic packing is restricted to low values, typically less than 200 centimeters per hour. Also, the use of large beads reduce the efficiency of the chromatographic packing, and necessitates the use of relatively long columns, typically more than 30 centimeters long. Yet another drawback is the softness of the water-swollen gels restricts the pressure gradient through the bed to levels that will not lead to bed compaction, which further restricts the velocities used to low levels. (See Jan-Christer Janson and Lars Ryden, Protein Purification, Wiley_LISS (1998), Sofer, G. and Hagel, L., Handbook of Process Chromatography, Academic Press (1997)).

As a consequence of conventional chromatographic packing characteristics, the separation of a mixture of compounds or the purification of a single compound is frequently controlled by the rate of diffusion of the compounds into and out of the beads comprising the chromatographic column. Even with the use of long chromatographic columns, the recovery of the desired compounds in pure form can be quite low, because the separation among the compounds is incomplete. In order to achieve adequate separation among the compounds, the chromatographic column has to be excessively large, and thus, need to use large quantities of solvent or buffer.

A still further undesirable consequence of the inefficiency of conventional bead chromatographic packings is the economic need to reuse these packings multiple times, as analyzed below. The combination of long columns and low velocities results in long cycle times, e.g., frequently several hours long. This in turn implies that a large amount of chromatographic packing is required to process a given amount of material. Chromatographic packings are expensive, typically costing more than $500 per liter. Because of this high cost, packings needs to reused many times over, processing anywhere from 50 to several hundred batches of material.

The need for this repeated use has very deleterious implications. For example, to maintain the properties of the column packing at a consistent level it is necessary to carry out meticulous CIP steps after each batch of material has been treated. These CIP cycles, over time, reduce the effectiveness of the packing. Because the column may be in use over a long period of time, weeks or months, any bacteria or other organisms that become trapped in the column and are not destroyed by the CIP cycle can proliferate and impact the purity of the material being processed. In order to meet the FDA's standards for manufacturing processes it is necessary to carry out extensive and costly quality assurance steps (QC) on packings that are reused in order to demonstrate that the packing properties remain consistent from run to run and that bacterial growth is under control. The cost of this QC work can exceed the cost of the separation step itself. Despite all of the above precautions, it is not possible to absolutely eliminate the possibility of some undesirable material from one batch of material contaminating the packing and compromising the purity batches processed subsequently on that packing. This can lead to problematic results, e.g., bad data collection, costly product recalls, etc.

The present invention, also referred to as MemCoat™, features a functionalized surface coating, uses, and processes for preparing various, more preferably large, surface area coatings having a porous structure, copolymers, and products of the process by interfacial polymerization with polymerization induced phase separation (PIPS). This novel invention features solutions to may of the restrictions, deficiencies, and drawbacks to currently used technologies and applications, e.g., chromatography.

### SUMMARY OF THE INVENTION

A new material has been developed and successfully applied to various applications, such as, solid-phase peptide synthesis, chromatography, array synthesis, and others. The present invention features a new matrix and its variants that will provide simple, cost-effective synthesis of low micromole-level peptides or two-dimensional arrays that are suitable for rapid biochemical screening (e.g., epitope and receptor mapping, protease specificity assays) as well as parallel sample handling operations.

In one embodiment, the polypropylene fiber sheet stock coated with an amino-functionalized polyurea is versatile, utilizes chemistry that is well-known in the coatings industry and is economical, e.g., starting materials are varied, abundant, and inexpensive. This coated material represent the first new support matrix reported in the past fifteen years for solid-phase peptide synthesis.

In one embodiment, the present invention features a design and corresponding apparatus for continuous coating of fiber sheet stock rolls width for example 2-30 cm to provide reproducible quantities of material for further studies. Furthermore, the present invention can optimize coating conditions, type of feedstock, loading. This application will help evaluate and optimize physical and chemical properties of the coated material and allow for the performance evaluation of these new materials in synthesis and bioassays. Thus, the present invention can be used to evaluate other applications of the coating technology, e.g., combinational chemistry, array synthesis of small molecules organic compounds for drug discovery, custom synthesized libraries of hundreds to thousand of peptides for activity testing, proteomics, bioactivity mapping, and immobilized peptides for diagnostic testing.

One aspect of the present invention is directed to a coated substrate featuring a functionalized polymeric surface and a polyurea and/or polyurethane network capable of accommodating a compound of interest. The polyurea and/or polyurethane network formed form the reaction, on at least a portion of the surface of the substrate.

Furthermore, the present invention features a versatile new material that features a coating consisting of a functionalized polymeric surface coating comprising reactive entities. These entities could consist of, for example, amino-, hydroxyl; epoxy- or other covalently linked in a polymer network of polyurea and polyurethane to provide a surface coating. This functionalized coating is applied to surfaces, for example, a non-woven material composed of fibers.

One embodiment of present invention is application of the coating to fibers at a level of 1 micromole/cm² amine, without poragens, to be utilized for peptide and combinational chemistry synthesis. Furthermore, the coating can be applied to a fiber at a high level with a crinkly fiber coating by the utilization of a poragen, thus creating a matrix having a higher loading on higher surface area for synthesis and other applications. In addition, the present invention features a process of applying for a maximum load coating. This method creates a matrix having macro-, meso-, and micro-pores.

In yet another embodiment, the present invention features improvements to chromatographic separation devices and processes used in the manufacture of compounds, for example, fine chemicals, pharmaceutical compounds proteins and peptides. The present invention also features further advantages, such as reducing the cost of chromatographic devices, avoiding of cross contamination between batches of material being processed chromatographically, and simplifying conformance with FDA manufacturing standards (CGMP).

### BRIEF DESCRIPTION OF THE FIGURES

FIG. 1 depicts a graph which represents the results of a protease assay of peptide linked to a polyruea matrix using the example of EKYDPTID on a low Load membrane during a typtic digest.

FIGS. 2A and 2B illustrate the result of a MemCoat™ Method 1 for coating fibers to a level of about 1 micromole/cm² amine with poragens.

FIGS. 3A through 3E depicts the coating of a fiber with a polymeric poragen.

FIGS. 4A through 4C represent high capacity substrates of MemCoat™ Method 2.

FIGS. 5A through 5D depicts the action of poragen in forming pour morphology in a macroporous resin.

FIGS. 6A through FIG. 6D depicts the background of microgelatin and the formation thereof.

FIGS. 7A and 7B depicts results of MemCoat™ Method 3 and the adjustable pore size and microgelation particle size of MemCoat™ Method 3 with R1 formulation and R2 formation.

### DETAILED DESCRIPTION

Some relevant definitions are as follows:

Functionalized is referred to in the present application as having a substrate able to react with a compound of interest.

Combinational chemistry is referred to in the present application as applications which employ a combination of chemistry and other sciences. For example, drug discovery and pharmacogneomics would be combinatorial chemistry.

Chromatography is defined as a process in which a chemical mixture carried by a liquid or gas is separated into components as a result of differential distribution of the solutes as they flow around or over a stationary liquid or solid phase.

Protein is defined as a series of amino acids of any length.

Peptide is defined as any various amides that are derived by two or more: any of various amides that are derived from two or more amino acids by combination of the amino group of one acid with the carboxyl group of another and are usually obtained by partial hydrolysis of proteins.

Proteomics is referred to in the present application as the effort to identify and characterize all of the proteins encoded in an organism's genome, including their posttranslational modifications.

The present invention is directed to a functionalized surface coating, products and uses of the coating. Furthermore, this application is directed to the process for preparing the surface coating having a porous structure, copolymers and products of the process.

The present invention developed an entirely new type of peptide synthesis support that permits the synthesis of peptides. Furthermore, the present invention features coating formulations and procedures to obtain material of high capacity yield, e.g., 2-4 μmoles/cm². Thus, the present invention demonstrates that peptides on coated fiber sheets are accessible to large macromolecules such as proteases and monoclonals, and that these materials can be used to prepare two-dimensional arrays of, for example, peptides and other organic compounds for rapid screening of bioactivity.

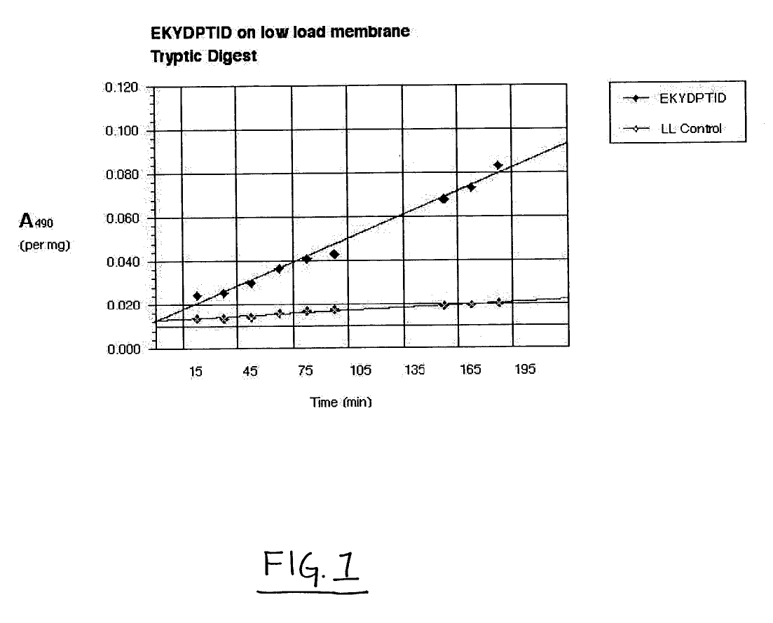

In particular, the present invention features a polyurea-coated fiber sheet which allows the fiber sheet to have an amino group capacity, for example, Ty-Vek 1059B of 39 NH₂ μmol/g, Ty-Vek 1073B of 35 μmol/, and glass fiber sheet (GF/C) of 114 μmol/g. Further results of the support matrix of one embodiment of the present invention can be found in Tables 1-6 and FIG. 1.

Initial testing of the present invention's substrates featured glass fiber sheets (GF/C, Whatman), two types of non-woven high density polyethylene sheets (Tyvek® 1059B and 1073 B, DuPont), as well as a loose no-woven polypropylene fiber sheet (PPF, Millipore). In one embodiment of the present invention, samples were treated with 10% polyisocyanate (N-100) in acetone and then with 50% diaminopropane in acetone. After washing, the amino group content was measured by the binding of picric acid or binding of 2,4,6-trinitrobenzene sulfonic acid. The results of these early embodiments are detailed below in Table 1. Although higher loading was seen for GF/C, it is brittle and is not the preferred support to embodied in this invention.

TABLE 1
Amino-group Capacity of Polyurea Coated Sheets

| | Ty-Vek | Ty-Vek | |
|---|---|---|---|
| | 1059B | 1073B | GF/C |
| NH₂ μmol/g | 39 | 35 | 114 |

The sample in table 1 was soaked in triflouroacetic acid for 1 hour and then washed with water 3 times and soaked in DMF overnight before the picric acid tests.

In a further embodiment of the polyurea coating material, a short peptide was synthesized on samples of polyurea-coated Tyvek and polypropylene membrane from Millipore. The peptide made was TYr(Fmoc-Gly-Lys-Phe-Asp-Leu-AM linker-Polyurea matrix. The Fmoc synthesis chemistry was used and the Fmoc group was left on the N-terminus to aid HPCL analysis. After cleavage from the resin, the amount from each support was measured quantitatively by HPLC (see Table 2).

TABLE 2
Relative Peptide Yields On Various Supports

| | Relative peak area per cm² |
|---|---|
| Matrix Support | (HPLC) |
| Millipore Sample | 1 |
| Ty-VEK | 1 |
| Polypropolene fabric | 3 |

In yet another embodiment of the present invention, a poragen, e.g., A-11, is added. Results from this embodiment are highlighted in Table 3. This embodiment increases porosity, for example, by adding a poragen such as Paraloid A-11 (an inert methyl (methacrylate resin). Furthermore, the poragens can be washed out and leave a spongy coating with a much high surface area. In particular, samples were coated as indicated in Table 3, and the resulting materials were used to synthesize the Fmoc-hexapeptide previously described. This embodiment yield nearly doubled when 30% of poragen (A-11) was added to the polyisocyanate (N-100).

TABLE 3
Effect of a Polymeric Poragen on Matrix Capacity as Measured by Peptide
Synthesis

| Matrix Support | μmol peptide/cm² |
|---|---|
| Millipore Sample | 0.22 |
| GF/C | 1.00 |
| PPF-Formulation-1 | 0.75 |
| PPF-Formulation-2 | 1.30 |

In still a further embodiment of the present invention, a variety of diamines of varying chain length, polarity and price are available, e.g., 1,2-Diaminopropane (NH₂(CH₂)₃NH₂); 1,7-Diaminoheptante ((NH₂(CH₂)₇NH₂); 1,12-Diaminododecane (NH₂(CH₂)₁₂NH₂); and Jeffamine D-230 (CH₃CH(NH₂)CH₂O(CH(CH₃)CH₂O)ₙCH₂CH(NH₂)CH₃. In particular, the Jeffamine family of diamines is of particular interest because they contain the polar polypropylene oxide (PPO) and polyethylene oxide (PEO) groupings, the latter which is found in most modern peptide synthesis resins. Furthermore, Table 4 shows the results of suing a polypropylene fiber sheet as a substrate and using 20% N-100/A-11 in a 70/30 solution in acetone and a 0.95 M diamine in CH₂Cl₂ (see Table 4).

TABLE 4
Effect of Diamine on Matrix Capacity

| | MW | μmol peptide/cm² |
|---|---|---|
| 1,2-diaminopropane | 74 | 2.8 |
| 1,7-diaminoheptane | 130 | 1.8 |
| 1,12-diaminoododecane | 200 | 3.9 |
| Jefffamine D-230 | 230 | 0.75 |

A further aspect of the present invention is its physical properties such as the nature of the matrix after coating, e.g., flexibility, uniformity of coating, etc. In one embodiment, a coating can occur without a coating machine, although a coating machine is preferred. Rather than dip substrates, e.g., PPF, sheets of PPF were placed in an open Petri dish containing mixtures of A-11/N-100. The solvent (acetone) was allowed to evaporate and the sheets where then transferred to solutions of Jaffamine D-230 and allowed to react overnight. Next, after washing the substrate with acetone and dimethylformamide, and drying, the sheets were asses for uniformity and flexibility, with one being the highest quality, and five, the lowest (see Table 5).

TABLE 5
Effect of Reagent Concentration on Coating Quality

| Expt. | Formulation | Coating Quality |
|---|---|---|
| 1 | 1 | 1 |
| 2 | 2 | 5 |
| 3 | 3 | 5 |
| 4 | 4 | 3 |
| 5 | 5 | 3 |

Moreover, in a further embodiment, the aforementioned procedures of the invention were carried out using a lower concentrations of reagent and capacity was assessed by hexapeptide synthesis (see Table 6).

TABLE 6
Effect of Reagent Concentration on Synthesis Capacity

| Expt. | Formulation | μmol/peptide/cm² |
|---|---|---|
| 11 | 1 | 3.4 |
| 12 | 2 | 3.4 |
| 13 | 3 | 3.4 |
| 14 | 4 | 3.8 |
| 15 | 5 | 1.8 |
| 16 | 6 | 3.8 |
| 17 | 7 | 2.6 |
| 18 | 8 | 4.8 |
| 19 | 9 | 1.8 |
| 20 | 10 | 4.5 |

In one particular embodiment of the present invention, a protease assay of a peptide was linked to a polyurea matrix. In this embodiment, Trypsin was used to cleave a 9-residue peptide bound to a polyurea matrix and tagged at the N-terminal with fluorescein. The released chromophore was measured by monitoring absorbance at 490 nm as a function of time for aliquots of tryptic digest (see FIG. 1).

In yet another embodiment of the present invention, various coatings applied to apparatuses, for example, microtiter plates and other surfaces. In particular, the present invention features optimizing coating chemistries by emphasizing the physiochemical properties of the present invention to refine and highlight the performance of the inventions applications. Furthermore, the present invention can be used for combinational chemistry applications, screenings and drug research, and discoveries.

Significant to the present invention was the development of MemCoat™ Methods for the creation of the functionalized polymer coating and products thereof.

The basic chemistry of making polyurea coatings consists of the reaction of an isocyante with an amine to form a urea, a stable linkage molecule. For example, a partially polymerized isocynate is generally used, both to convert it to a multidentate molecule (e.g., dimer or trimer) and to lower the vapor pressure making it less toxic. The polyisocyantes that are preferred are the desmodour series manufactured by Bayer® and are derived from heamehtylen diisocyane. In one-step of the coating process, the polyolefin sheet stock (e.g., polypropylene fiber is passed through a bath of, for example, Desmodur N-100, in a solvent such as acetone. As the solvent evaporates, the coated sheet becomes exposed to traces of water in the air that hydrolyzes some of the NCO groups to amines, which in turn react with other NCO groups, thus resulting in further polymerization:

R—NCO+H₂O→R—NH₂+CO₂

R—NH₂+RNCO→R—NH—CO—NH—R (urea)

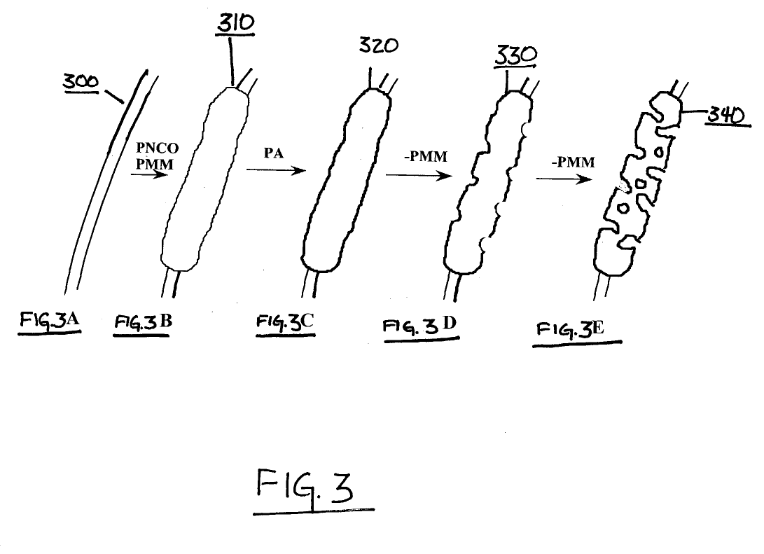

In the next step, the coating process is to pass the polyisocyanate-coated sheet through a polyamine that causes further crosslinkage and results in a crosslinked copolymer containing untreated amino groups. These amino groups are then used as anchors for the synthesis of peptides such as Jeffamines from Fluka and Huntsman Chemicals. This reaction is further described in FIG. 3.

In addition, the present invention can also feature a variety of coatings used in the industry and are available in many formulations such as resins (e.g., desmodur N-100 polyisocyanate dimer/trimer, desmodur N-2200 polyisocyanate trimer), poragen (e.g., Paraloid A-11 (polymethylmethacrylate), and di-triamine crosslinkers (e.g., Jeffamine D-230, and Jaffamine T-40). Jaffamines are preferred in the coatings for because they have relatively low vapor pressures result in reduces toxicity. Furthermore, Jeffamines contain polyethylenoxy moieties, which make them somewhat hydrophilic and solvated by water. Compatibility with water is essential, for example, when doing bioassays or immobilized peptides. The present invention can also feature variations of the polyamine and polyisocyanate types and ratios, which will result in a wide range of coating properties.

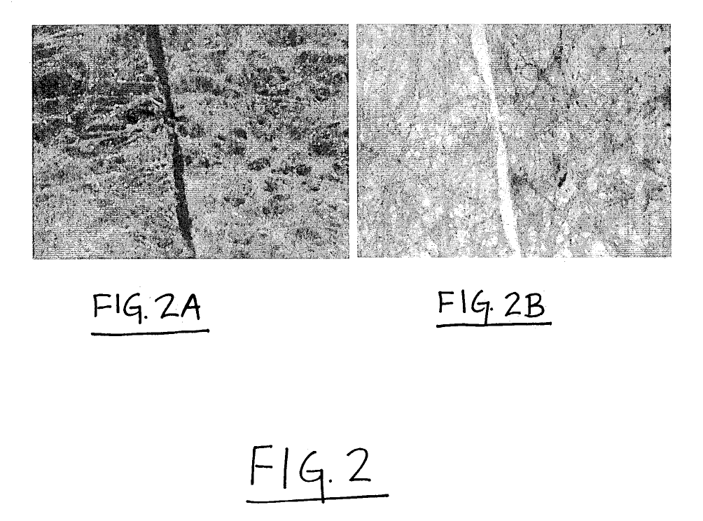

In particular, one preferred embodiment utilizes MemCoat™ Method 1 to coat fibers to a level of about 1 micromole/cm² amine without the use of poragens (see FIGS. 2A and 2B). This method is useful is several applications such as peptide and combinational chemical synthesis.

In yet another embodiment of the present invention, MemCoat™ Method 2 coats fibers at a higher level with a crinkly fiber coating by using a poragen, e.g. poly(methyl methacrylate) (PMM). This matrix provides the advantage of a higher loading due to a higher surface area. This application would be ideal for applications requiring a scaled up synthesis and/or other applications in proteomics, genomics, combinational chemistry, and chromatography to name a few. FIG. 3 further illustrates this embodiment.

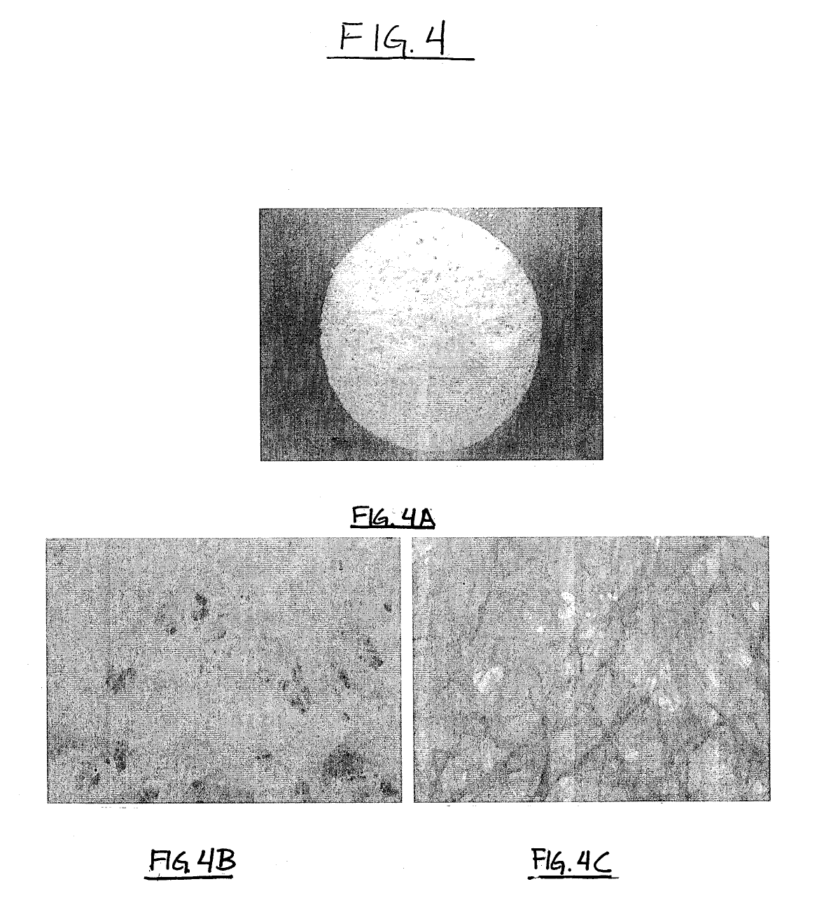

FIG. 3 illustrates a polymeric poragen in the coating material. Specifically, FIG. 3A depicts the bare fiber as it is immersed in a mixture of polyisocyanate (PNCO) and poragen (poly(methyl methacrylate), (PMM) to give a coated fiber. Next, FIG. 3B depicts the coated fiber which is obtained is then treated with a polyamine (PA). Upon treatment with a polyamine (PA), a cross-linked surface film is formed (see FIG. 3C). FIG. 3D depicts that the coated fiber's poragen, while still in the polyamine solution, begins to dissolve forming pores and allowing the cross-linking amine to penetrate even further. As more poragen dissolves, the process continues yielding a spongy solid with a high surface area as illustrated in FIG. 3E. These results are also illustrated in FIGS. 4A through 4C.

FIG. 4A depicts a high capacity substrate of 3400-D-1-504 at a magnification of 10×. Furthermore, FIG. 4B depicts the same substrate at a magnification of 60× and FIG. 4C magnifies the substrate to 60×. These magnifications highlight he porous nature of the substrate allowing for the high load capacity.

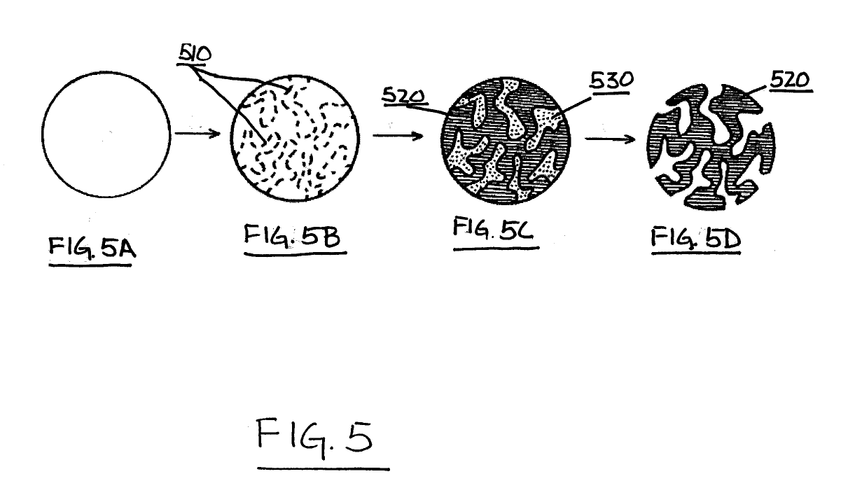

Yet another important aspect of the present invention is the action of poragens in forming porous morphology in a macroporous resin. For example, FIG. 5 depicts one possible formation of a poragen forming a porous morphology. FIG. 5A depicts a monomer, crosslinker, and poragen isotropic solution. Next, polymerization occurs allowing a polymer network to form (see FIG. 5B). FIG. 5C illustrates the poragen and a network start to phase separately and the poragen phase acts a pore template. Finally the poragen phase is removed to yields pores creating a porous surface (see FIG. 5D). (See Sherrington, Chem. Comm. 2275-2286 (1998)).

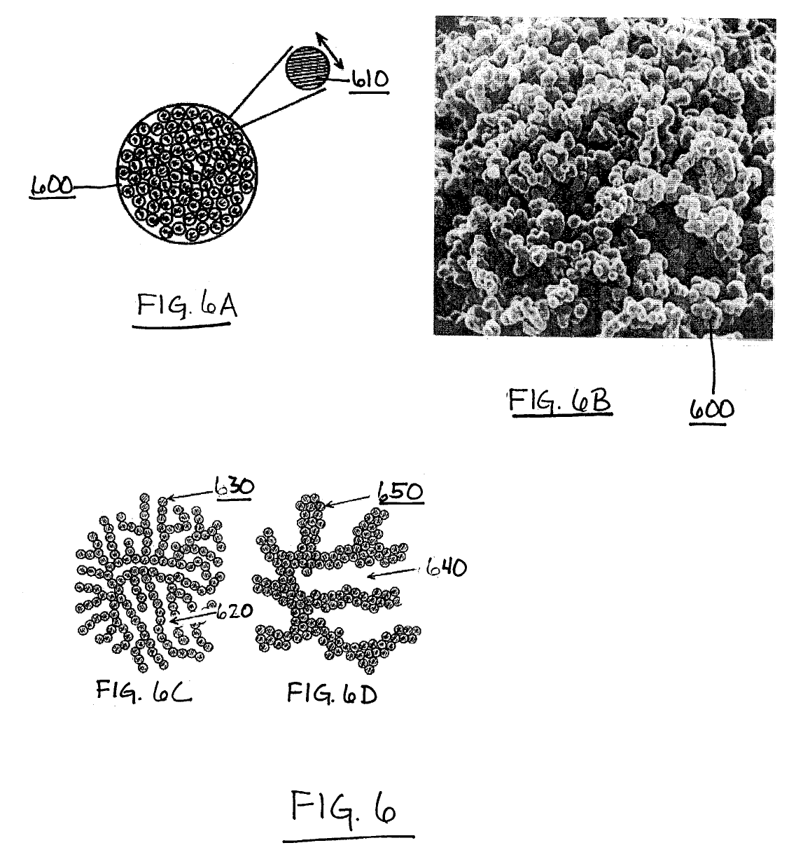

Another important aspect of the present invention is microgelation as depicted in FIG. 6. FIG. 6A illustrates a macroporous resin bead showing an individual microgel particle which is about 1000 Å. Furthermore, FIG. 6B depicts a scanning electron micrograph of a macroporous resin fracture section at a magnification of 5000×. FIGS. 6C and 6D highlight the connectivity of microgel particles showing the formation of small pores forming a network of interconnected individual microgel particles. The larger pores then form a network of fused or aggregated microgel particles. (See Id.)

Another embodiment of the present invention, MemCoat™ Method 3, is an interfacial polymerization with polymerization induced phase separation (PIPS) technology. This method features interfacial polymerization with monomers approaching each other in an interfacial manner for the polymerization reactions. Also, featured in this embodiment is the polymerization induced phase separation (PIPS) that results in a microgelation morphology and agglomeration of submicron particles for a large surface area. This technique has created a route to isolate a desired compounds, for example, via the above-identified methods with adjustable pore sizes and microgelation particle size.

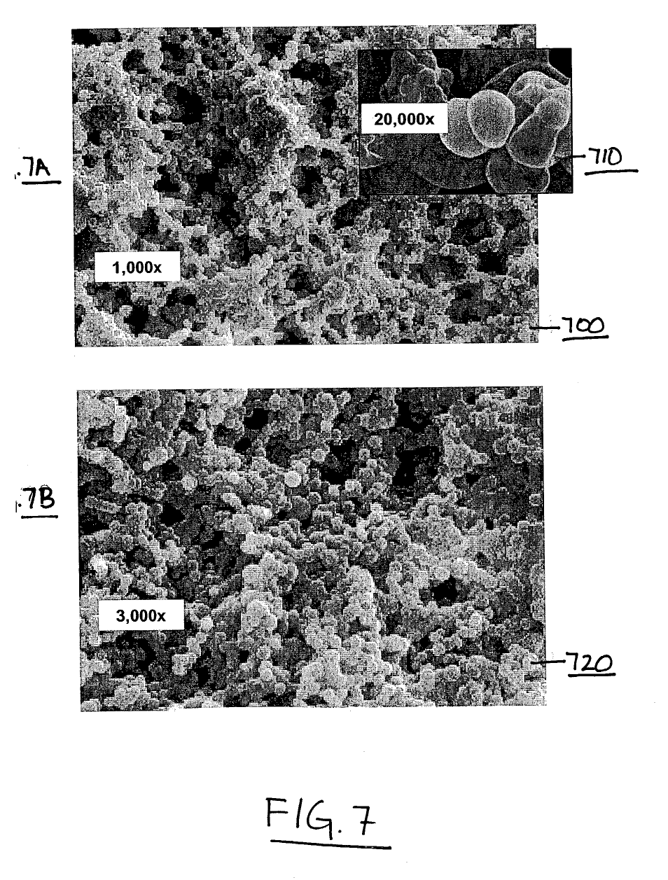

FIG. 7 depicts some of the MemCoat™ Method 3 results and, in particular, highlights the adjustable pore size and microgelation particle size of MemCoat™ Method 3 with R1 formulation and R2 formation. FIG. 7A is a 1,000× and 20,000× magnification of the R1 formulation, while FIG. 7B is a 3,000× magnification of the R2 formulation.

In addition, the present invention features production capability of the aforementioned compounds, combinations, methods, and structures by utilizing, for example a 30-cm web transport, a slot applicator, drying box which can produce at 1-5 feet per minute.

Another preferred embodiment features solutions to deficiencies in currently used applications, e.g. chromatography. In particular, the previously discussed deficiencies of chromatographic packings based on beads can be largely overcome by a novel packing based on non-woven fabrics whose constituent fibers are coated with a thin layer of chromatographic adsorbent, e.g., typically less than about 10 micrometers. The high void fraction of the non-woven fabric combined with the thinness of the chromatographic coating allows one to carry out chromatographic separation on these materials at high rates and with excellent efficiencies and low-pressure drops. The non-woven packing can be configured as a chromatographic column in a variety of ways. One possible arrangement is to pile up multiple layers of circular discs, which mimics directly the shape of a conventional column. Another design example is to roll up the fabric as a spiral around a porous tube and encase this assembly in a pipe, allowing a small gap between the pipe and the outer diameter of the roll of fabric. The flow direction in this design is radial. Yet another approach is to roll up the fabric as a spiral and the flow direction is along the axis of the cylinder of fabric. These examples provide more rapid separations of mixtures with higher efficiencies than are possible with conventional packings.

With regard to the problems of reusing the same chromatographic packing for processing multiple batches of material, the present invention allows for size adjustment of individual chromatographic columns and velocities used, enabling use of small amounts of chromatographic packing, multiple times, to process an entire batch of material. For example, if a chromatographic packing can be used to process 100 batches of a certain material before losing its effectiveness, one embodiment of the present invention could employ a chromatographic column so small that it would need to be operated approximately 100 times to process one batch of material. By this means, the total use of packing per quantity of material processed would be the same for the small column, processing one batch of material, versus a large column processing 100 batches of material. The present invention allows the benefit of using fresh chromatographic packing for every batch of material without the cost penalty of disposing packing prematurely.

One embodiment utilized a chromatographic adsorbent in chromatographic packing comprising single or multiple layers of non-woven fabric coated with. This fabric can consist of non-woven fabric with various pour sizes, more preferably, a pore size of less than 40 micrometers. Also, this non-woven fabric can have a wide range of a void fraction of between about 25% to 95%, including between about 30% to 90%, e.g., 30% to 90%, in its uncoated form. Furthermore, when this non-woven fabric is coated with the adsorbent material of the present invention, it void fraction can range from between about 15% to 45%, including between about 20% to 40%, e.g., 20% to 40% of the initial void fraction.

The present invention may also feature chromatographic packing made of a non-woven fabric with various fiber diameters, for example, the average diameter fiber ranging from between about 2 to 40 micrometers, including between about 3 to 30 micrometers, e.g., 3 to 30 micrometers.

One preferred embodiment features non-woven fabrics as a substrate for chromatographic adsorbents. In particular, non-wovens have excellent combinations of void-fraction and fiber diameter. These combinations permit the coating of the fibers with thin (several microns) adsorbent layers. The combination of high porosity with thin adsorbent layers results in a chromatographic adsorbent with high efficiency, for example, low HETP˜0.1 mm, good capacity and very low pressure drop. The resulting chromatographic devices will have a high dynamic capacity for proteins even when operated at high (500 to 1,000 cm per hour) velocities. The combination of high dynamic capacity and high flow rate can lead to disposable chromatographic columns for various applications. As well as the additional advantage of the low cost of non-wovens can result in very inexpensive chromatographic packings.

One embodiment of the present invention features a chromatographic bed, in the direction of flow of various lengths, for example, less than 4 centimeters. Also featured in this embodiment is a chromatographic cycle which can range from between about 50 and 1500 centimeters per hour, including between about 100 to 1000 centimeters per hour, e.g., 100 to 1000 centimeters per hour.

Further advantages of the present invention allow for several methods and embodiments to be used at once. Various methods of the present invention can include any the embodiments described herein, such as, the chromatographic processes and/or involve one or more systems concurrently, e.g., a combination of one or more chromatographic column, assay screening, DNA synthesis from data, protein binding assays, purification, and more.

In yet another embodiment, the present invention provides a process, which produces a uniform coating on the fibers. Also, the embodiment provides the further advantage that the chemicals, which are used in the process, are inexpensive and readily available.

One embodiment provides that the process and chemistry produce very high capacities. For example, the chemistry is adaptable to various modalities, cation exchange, anion exchange, affinity, etc. Furthermore, the basic coating techniques have been demonstrated on a bench-top continuous coater capable of making hundreds of square feet of material.

In addition, the present invention features embodiments that are applicable for making fouling resistant ultra filtration membranes, applying cationic or anionic charges to ultra filtration membranes, improving membranes rejection properties, involving various types of analytical devices, purifying, and synthesizing DNA, proteins, large molecules, proteins, peptides and other various arrays.

### EXEMPLIFICATION

### EXAMPLE 1

(Method-1)

A 12.5 mm (1.3 cm², 4 mg) diameter disk was cut from a bi-component polypropylene/polyethylene substrate (Freudenberg, F02465) and rinsed with n-hexane to remove organic contaminants, and air-dried at ambient conditions.

A 40 ul aliquot of aliphatic polyisocyanate “prepolymer” (Bayer Desmodur™ N-3400) in acetone (7.5/92.5) was added to the disk, which was allowed to air dry for 60 minutes at ambient conditions. After drying, the mass gain was 2 mg.

The polyisocyanate-coated disk was submerged in a saturated solution (ca. 0.5%) of a triethyleneglycoldiamine (Huntsman, Jeffamine™ XTJ-504) in n-hexane for 3 hours to effect polymerization. After this incubation, the disk was transferred directly to a 5% solution of the same amine in acetone for 1 hour.

The disk was washed in water and acetone and air dried for 1 hour. Additional mass gain was 1 mg.

Amine loading was measured as 0.82μ moles/cm² (157μ moles/g) by the picric acid test.

The fiber coating was observed at 320× under a light microscope and at 1000-7,500× under an electron microscope. All fibers appeared to be coated with only minimal polymerization in the interstitial spaces.

### EXAMPLE 2

(Method-2, Polymeric Poragen, also see Phase II Application and Phase I Report Data)

A 12.5 mm (1.3 cm², 4 mg) diameter disk was cut from a bi-component polypropylene/polyethylene substrate (Freudenberg, FO2465) and rinsed with n-Hexane to remove any organic contaminants, and air-dried at ambient conditions.

An aliphatic polyisocyanate “prepolymer” (Bayer Desmodur™ N-3400) and a poragen were dissolved in solvent (1:1 acetone: butyl acetate) to provide a coating mixture that was 90/9/1 (solvent/isocyanate/poragen). The mixture (40 uL) was added to the disk and allowed to air dry for 60 minutes at ambient conditions.

The coated disk was submerged in a saturated solution (ca. 0.5%) of a triethyleneglycoldiamine (Huntsman, Jeffamine™ XTJ-504) in n-hexane for 3 hours to effect polymerization. After this incubation, the disk was transferred directly to a 5% solution of the same amine in acetone for 1 hour.

The disk was then washed in water and acetone and air dried for 1 hour.

Amine loading was measured at 2-4μ moles/cm² by the picric acid test.

### EXAMPLE 3

(Method-3, Microgelation-1)

A 12.5 mm (1.3 cm², 4 mg) diameter disk was cut from a bi-component polypropylene/polyethylene substrate (Freudenberg, FO2465) and rinsed with n-Hexane to remove any organic contaminants, and air dried at ambient conditions.

A solution (40 uL) of polyisocyanate “prepolymer” (Bayer Desmodur™ N-3400) in N,N-dimethlyformamide (6:4 by weight) was transferred onto the disk.

The disk was blotted to remove excess isocyanate/DMF solution and allowed to air dry and cure for 60 minutes at ambient conditions.

The coated disk was transferred to a saturated solution (ca. 0.5%) of a triethyleneglycoldiamine (Huntsman, Jeffamine™ XTJ-504) in n-hexane and allowed to stand for 3 hours. The disk was transferred directly to a 5% solution of the same amine in acetone and allowed to stand for one hour at ambient conditions.

The disk was then washed with water/acetone and air dried for 1 hour. The weight of the final product was 5 mg, i.e. an increase of 1 mg.

Amine loading was measured as 4.45μ moles/cm² (229μ moles/g) by the picric acid test.

### EXAMPLE 4

(Method-3, Microgelation-2)

A 12.5 mm (1.3 cm², 4 mg) diameter disk was cut from a bi-component polypropylene/polyethylene substrate (Freudenberg, FO 2465) and rinsed with n-Hexane to remove any organic contaminants, and air-dried at ambient conditions.

An aliphatic polyisocyanate “prepolymer” (Bayer Desmodur™ N-3400) with dimethylformamide (9:1), was dissolved in a solvent (1:1 ethyl acetate:butyl acetate) to provide a coating mixture that was 90/9/1 (solvent/isocyanate/DMF). The coating mixture (40 uL) was transferred to the disk, which was allowed to air dry and cure for 60 minutes at ambient conditions. The mass gain was 4.8 mg.

The coated disk was transferred into a saturated solution (ca. 0.5%) of a triethyleneglycoldiamine (Huntsman, Jeffamine™ XTJ-504) in n-Hexane and allowed to stand for 18 hours ambient temperatures.

The disk was washed in water and acetone and air-dried for 1 hour. Additional mass gain was 0.8 mg.

Amine loading was measured as 1.51 μ moles/cm² (199μμ moles/g) by the picric acid test.

The fiber coating was observed at 320× under a light microscope and at 1000-7,500× under an electron microscope. All fibers appeared to be coated with only minimal polymerization in the interstitial spaces.

Materials and Methods

Solvents:

Acetone, p/n 27,072-5, butyl acetate, p/n 27,068-7, ethyl acetate, p/n 27,098-9, and hexane, p/n 27,050-4 were from Sigma-Aldrich (Milwaukee, Wis.) In example 3 the Desmodur™ solution was made using N,N-Dimethylformamide p/n 40250 was from Fluka, AG (Buchs, Germany). Ethanol, p/n 241HPLC200 and methylene chloride p/n 313000DISCS4C were from Pharmaco Inc. (Brookfield, Conn.).

Polyisocyanate:

The polyisocyanate was Desmodur N-3400 (Bayer, Pittsburgh, Pa., p/n DH5). Other Desmodurs were tested including N-100, N-3200, and N-3600.

Amines:

The bi-functional amine was Jeffamine-XTJ-504 (Huntsman, Austin, Tex.). Other amines included Jeffamine T-403 and Jeffamine T-5000. Diiosopropylethylamine, p/n 7087-68-5, was from Sigma-Aldrich.

Substrates:

Various nonwoven materials made of polypropelyene, polyethylene, and composites thereof were utilized. The preferred nonwoven materials were p/n FO2465 from Freudenberg AG, (Weinheim, Germany) and p/n T8319-064 from US Filter Co. (Timonium, Md.).

Poragens:

5 Polymeric poragens were Cellulose Acetate Butyrate (Eastman, p/n CAB-171-15), Poly(ethylene glycol) dimethyl ether (Aldrich, p/n 44,590-8), Acryloid™ A11 (Rohm and Haas) and mineral oil (Sigma, p/n M5904)

Picric Acid Test:

Amine yields were determined by the reversible reaction with picric acid. The disk was dipped into 0.1M picric acid in ethanol and washed up to five times in methylene chloride until all nonbound picric acid had been removed. The disk was then placed in 1 mL of 5% disopropylethylamine in ethanol (V/V) and allowed to stand for 1 hour. The resulting solution was appropriately diluted with ethanol and measured on a spectrophotometer at an absorbance of 358 nm using an extinction coefficient of 14,500.

### EXAMPLE 5

Coated Non-woven Fabrics as Chromatographic Media

The following example is illustrative of the benefits of the use of coated, non-woven fabrics as chromatographic media.

The number of cycles to process a batch of material, N_{cycles}, is simply the number of hours allotted to processing the batch divided by the cycle time of the chromatographic process. A typical time allotted to process a batch of material might be 8 hours (one shift) and the number of cycles defining the life of chromatographic packing might be 100. This implies that the chromatographic cycle needs to be 8/100 hours long, or about five minutes. By designing the column to achieve a cycle time of five minutes, the present inventions avoids the reuse of packing for multiple batches of feed material, without premature disposal of the packing and the consequent cost penalties.

This requirement of a very short cycle time can be met if:

The packing is highly efficient so that it can be used at high flow rates.

The efficiency must be so high that the packing depth can very low.

The packing needs to be rigid so that it will not be compressed by the large pressure gradients resulting from the use of high flow rates.

In general, these goals can be attained by using chromatographic packings comprising a coated non-woven fabric, having characteristic dimensions on the order of several micrometers and adsorptive capacities of more than 10 milligrams protein per milliliter of packing. Preferred chromatographic packings having these characteristics are obtainable by imparting to a non-woven material, with pore sizes of less than about 30 micrometers, surface properties that enable them to function as chromatographic adsorbents, ion exchange groups, or other ligands.

In a typical chromatographic separation, about 20 column volumes of fluid pass through the column in the course of one cycle. If it is desired to keep the cycle time at 0.08 hours, then the ratio of column length to the average fluid velocity is 0.08/20 or 0.004 hours. Any combination of column length divided by average velocity that equals less than 0.004 hours will result in a large enough number of cycles to process a batch of material with one batch of chromatographic packing. Non-woven chromatographic packings have very low diffusional resistance because the fluid flows within, preferably, a few microns from the adsorptive surface, and the thickness of the coating on the fibers is only a few micrometers. This packing permits the use of high velocities without serious loss of separation efficiency. Flow velocities of 300 centimeters per hour are therefore common. At a flow velocity of 300 centimeters per hour, the packing depth or length will therefore be 0.004 times 300, or 1.2 centimeters. If it were desired to use lower velocities to obtain exceptionally good separations, say 100 centimeters per hour, the corresponding column length could be as short as 0.4 centimeters. Conversely, if one used a higher velocity the column length could be increased. Since suitable non-wovens are typically 0.01 to 0.04 centimeters thick, it is relatively straightforward to place a sufficient number of non-woven layers on top of each other to obtain any desired packing thickness.

The present invention allows the ability to carry out virtually any chromatographic separations in such a way that one small column, composed of membrane based packing, is used multiple times to process an entire batch of material as long as the column thickness or length is less than about 4 centimeters. The only requirements placed on the column packing are that it be have a pore size of less than about 30 microns and that it be rigid enough to sustain the pressure drops resulting from the use of high velocities.

In some cases, it may be convenient to use several small columns, operated simultaneously, in order to process particularly large batches of material. The goals of the invention are still met if the number of chromatographic cycles for each column matches the maximum number of cycles that the packing can undergo without loss of effectiveness.

### Example 6

The Beneficial Properties of Non-Wovens Coated with Polyurea Based Coatings Used as a Chromatographic Adsorbent

The following example illustrates the beneficial properties of non-wovens (Freudenberg FO 2465) coated with Polyurea based coatings when used as a chromatographic adsorbent. The table below lists typical adsorption capacities for bovine serum albumin (BSA) for a number of coating types.

| | | | | mg/ml |
|---|---|---|---|---|
| MemCoat-X | Type | | μg/cm² BSA | BSA |
| DETA-NH₂ | 1 | BP | 350 | 10.5 |
| DETA-NH₂ | 3 | BP | 700 | 21.0 |
| DMDPA-NH₂ | 1 | BP | 300 | 9.0 |
| 403-N-(CH₃)₃⁺ | 1 | TC | 230 | 4.6 |
| DETA-N- | 1 | TC | 650 | 19.6 |
| (CH₃)₃⁺ | | | | |
| DMDPA-N- | 1 | TC | 600 | 18.0 |
| (CH₃)₃⁺ | | | | |

The last column shows the adsorptive capacity for BSA as measured in mg per cubic centimeter of coated fabric.

The uncoated fabric had a fiber diameter of about 15 micrometers and a void fraction of about 90% and a pore size of about 130 micrometers. An amount of coating, about 4% by weight of the fabric, was applied. The resulting fabric had a pore size of about 86 micrometers and a void fraction of about 86%. The slight reduction in void fraction and pore size indicate that the pressure drop through the coated fabric would be only slightly larger than the pressure drop through the uncoated fabric.

Furthermore, the thickness of the adsorptive coating on the fibers is only about 1.1 micrometers. This indicates that diffusional resistance in this coating would be extremely small as compared to conventional bead type chromatography media that have diffusion distances ranging from 5 to over 100 micrometers.

The combination of the high void fraction and large pore size permit chromatographic operation at very high flow rates with minimal pressure drops and very low diffusional resistance, allow extremely rapid cycling of a chromatographic device comprising this type of non-woven material. This rapid cycling in combination with the high adsorptive capacity leads to very high production rates per volume of chromatographic medium.

The capacity of this fabric could be substantially increased by applying more Polyurea while still maintaining without compromising the efficiency of the coating. For example, a capacity of 50 mg HSA per cubic centimeter of fabric could be achieved with a coating thinness of about 3 micrometers.

In the examples, all parts and percentages are by weight, except where noted.

### EQUIVALENTS

Those skilled in the art will recognize, or be able to ascertain using no more than routine experimentation, many equivalents to the specific embodiments of the invention described herein. Such equivalents are intended to be encompassed by the following claims.

The entire contents of all references, patents, patent applications, grant and grant applications cited herein are expressly incorporated by reference.

We claim:

1. A composition comprising a substrate having a functionalized polymeric surface coating comprising a polyfunctionalized polyurea or polyurethane.

2. A composition according to claim 1, wherein the polyurea or polyureathane contain functional groups selected from the group consisting of an amino-, hydroxyl-, and epoxy-.

3. A composition according to claim 1, wherein said polyurea or polyurethane forms a crosslinked polymer network.

4. A composition according to claim 1, wherein the functional groups are present between about 0.05 to 2.0 micromole/cm², including between about 0.1 to 1.0 micromole/cm².

5. A composition of according to claim 1, wherein the functional groups are present in excess of 0.01 micromole/cm².

6. A composition according to claim 1, wherein the functional group is an amino group.

7. A composition according to claim 1, wherein the substrate comprises fibers of a non-woven material having a diameter of between about 1 and 15 microns, having a void fraction of between about 50% and 80%, and wherein said fibers being coated with the functionalized polymeric surface coating such that the polymeric surface coating occupies between about 20% and 40% of the initial void fraction.

8. A composition according to claims 1, wherein the composition is applied to an application selected from a group consisting of: chromatography, purification, protein binding assay methods, peptide synthesis with LC data on a peptide, data synthesis with data from IDT, DNA synthesis, protein synthesis, combinational chemistry, peptide synthesis, proteonomic activities, bioactivity mapping, and immobilized peptides for diagnostic testing.

9. A method of preparing a functionalized polymeric surface coating on a substrate to be coated comprising:
(a) forming a mixture of an aliphatic or aromatic amine with isocycnate creating a polymer;
(b) cross-linking the polymer with an amine to form a polyaminated polyurea; and
(c) applying said mixture to said substrate to form the functionalized polymeric surface coating.

10. A method according to claim 9, further comprising the step of contacting the functionalized the polymeric surface coating with a compound of interest under conditions which allow the compound of interest to react with the functionalized polymeric surface coating.

11. A method according to claim 9, wherein the compound of interest is a peptide or protein.

12. A method according to claim 9, wherein the compound of interest is isolated during peptide synthesis.

13. A method according to claim 9, wherein the substrate is a peptide or protein arrays.

14. A method according to claim 9, wherein the compound of interest is isolated during epitope mapping.

15. A method according to claim 9, wherein the compound of interest is a peptide or protein isolated during peptide syntheses.

16. A method according to claim 9, wherein the compound of interest is DNA.

17. A method according to claim 9, wherein the compound of interest is isolated during DNA synthesis.

18. A functionalized polymeric surface coating comprising reactive entities, such as amino-, hydroxyl, or epoxy-, covalently linked in a polymer network of polyurea or polyurethane) to provide a surface coating wherein said reactive entities are present in excess of 1 micromole/cm².

19. A functionalized polymeric surface coating according to claim 16, wherein said functionalized polymeric surface coating is applied to the fibers of a non-woven material composed of fibers having a diameter of between 1 microns and 15 microns with a void fraction of between 50% and 80% and the surface of said fibers being coated with the functionalized surface coating such that the polymeric surface coating occupies between 20% and 40% of the initial void fraction.

20. A polymerization process in which one monomer unit approaches another monomer unit containing a liquid precipitant in an interfacial manner resulting in polymerization induced phase separation (PIPS) to provide a cross-linked polymer with a microgelation morphology, an agglomerization of sub-micron sized particles, and a product with high specific surface area.

21. A composition according to claim 1, wherein the substrate is a chromatographic adsorbent;
and the chromatographic adsorbent is used to coat a single layer of non-woven fabric for a chromatographic packing.

22. A further composition of claim 21, wherein the chromatographic adsorbent coats multiple layers of non-woven fabric.

23. A further composition of claim 21, wherein non-woven fabric with an average pore size of less than 40 micrometers.

24. A further composition of claim 21, wherein the non-woven fabric with a void fraction of between 90% and 30%, in its uncoated form.

25. A further composition of claim 21, wherein the non-woven fabric with between 20% and 40% of the initial void fraction being filled with adsorbent material.

26. A further composition of claim 21, wherein a non-woven fabric with an average fiber diameter of between 3 and 30 micrometers.

27. A further composition of claim 21, wherein the chromatographic packing further comprises a chromatographic bed thickness of less than 4 centimeters in the direction of flow;
and the average velocity used during the chromatographic cycle is between about 100 and 1000 centimeters per hour.

28. A method of chromatographic process, wherein the chromatographic packing of claim 21 is used in a single column.

29. A method of chromatographic process, wherein the chromatographic packing of claim 21 is used in more than one column.
